(19) United States
(12) Patent Application Publication
(10) Pub. No.: US 2019/0132012 A1
(43) Pub. Date: May 2, 2019

(54) APPARATUS FOR AUTOMATION TECHNOLOGY

(71) Applicant: Endress+Hauser Process Solutions AG, Reinach (CH)

(72) Inventors: Vincent De Groot, St. Louis (FR); Francois Ichtertz, Dornach (CH)

(21) Appl. No.: 16/096,058

(22) PCT Filed: May 18, 2017
(86) PCT No.: PCT/EP2017/061920

§ 371 Date: Oct. 24, 2018

(30) Foreign Application Priority Data
May 25, 2016 (DE) 10 2016 109 650.4

(51) Int. Cl. H04B 1/00; G05B 19/042; H04B 1/38

(52) U.S. Cl. CPC H04B 1/0053; G05B 19/0423; H04B 1/38; G05B 2219/33192; G05B 2219/31103; G05B 2219/31104; G05B 2219/25186

(57) ABSTRACT

Apparatus for automation technology, comprising: a housing, a radio antenna externally mounted on the housing, a communication electronics arranged within the housing and data conductively connected with the antenna and adapted to communicate data, preferably process data, bidirectionally according to a first radio standard wirelessly via the antenna to and from a superordinated unit, which communication electronics is, furthermore, adapted to communicate data, preferably parameter data, bidirectionally according to a second radio standard wirelessly via the antenna to and from a service unit.

The invention relates to an apparatus for automation technology, a field device, a radio adapter, a system of automation technology and to a method for parametering a field device and/or a radio, or wireless, adapter.

In process automation technology, field devices are often applied, which serve for registering and/or influencing process variables. Examples of such field devices are fill-level measuring devices, mass flow measuring devices, to pressure- and temperature measuring devices, etc. In such case, sensors register the corresponding process variables, such as, for example, fill level, flow, pressure and/or temperature.

Serving for influencing process variables are actuators, e.g. valves or pumps, is via which e.g. the flow of a liquid in a pipeline section, or the fill level in a container, can be changed.

Referred to as field devices are, in principle, all devices, which are applied near to the process and which deliver, or process, process relevant information.

A large number of such field devices are manufactured and sold by the firm, Endress+Hauser.

In modern industrial plants, field devices are, as a rule, connected with superordinated units via fieldbusses. Normally, the superordinated units are control systems, or control units, such as, for example, a PLC (programmable logic controller). The superordinated units serve, among other things, for process control, process visualizing, process monitoring as well as for start-up of the field devices. The process variables registered as data by the field devices, especially by their sensors, are transmitted via the connected fieldbus to one or, in given cases, even a number of superordinated unit(s). Along with that, also a data transmission from the superordinated unit via the bus system to the field devices is required; this can serve, for example, for diagnostic purposes. In general, the field device is serviced via the fieldbus from the superordinated unit.

Besides a wired data transmission between the field devices and the superordinated unit, there is also the possibility of a wireless data transmission. For implementing a wireless data transmission, newer field devices, especially sensors and actuators, can be embodied as radio field devices. These have, as a rule, a corresponding communication electronics and antenna as components. Along with that, there is the possibility of to upgrading field devices lacking a radio unit to a radio field device by coupling with a radio adapter, or wireless adapter.

In the case of each first installation or in the case of a device replacement, both the radio adapter as well as also the field device must be configured, or parametered.

Used for this are so-called service units, for example, in the form of a portable computing unit (PC, laptop), in which special service- and/or observation software run. Available service- and/or observation software includes, for example, the software “FieldCare” of the Endress+Hauser group of companies. For parametering a field device or even a radio, or wireless, adapter, the service units are connected with the field device, or radio adapter, wired via a USB- or even a serial COM interface (RS232, RS485) with the assistance of an apparatus for the transmission of the configuration- and/or parameter data. In order that this wired connection can occur, the housing of the field device, or of the radio, or wireless, adapter, must be manually opened and the cable appropriately connected to the electronics.

It is, consequently, an object of the invention to provide a simplified parametering of a field device, or a radio, or wireless, adapter.

The object is achieved by an apparatus for automation technology, a field device, a radio adapter, a system of automation technology and a method for parametering a field device, or radio, or wireless, adapter.

As regards the apparatus for automation technology, the object is achieved by an apparatus for automation technology, comprising:
a housing,
a radio antenna externally mounted on the housing,
a communication electronics arranged within the housing and data conductively connected with the antenna and adapted to communicate data, preferably process data, bidirectionally according to a first radio standard wirelessly via the antenna to and from a superordinated unit, which communication electronics is, furthermore, adapted to communicate data, preferably parameter data, bidirectionally according to a second radio standard wirelessly via the antenna to and from a service unit.

According to the invention, thus the communication electronics in interaction with the radio antenna is embodied in such a manner that it can transmit and receive data according to two different radio standards. In this way, no second radio antenna placed externally on the housing is necessary for the second radio standard.

An advantageous, further development of the invention provides that both the first radio standard as well as also the second radio standard operate based on the IEEE 802.15.4 standard. Especially, the further development provides that the wireless transmission occurs in the case of both radio standards at essentially the same radio frequency.

Another advantageous, further development of the invention provides that the first radio standard comprises wireless HART or ISA100.11a.

In turn, another advantageous, further development of the invention provides that the second radio standard comprises Bluetooth or a variant modified therefrom, for example, Bluetooth LE.

In turn, another advantageous, further development of the invention provides that the housing comprises a metal housing body or a housing body of a synthetic material, e.g. a plastic, resistant to radio transmission.

As regards the radio, or wireless, adapter, the object of the invention is achieved by a radio adapter for automation technology, which includes an apparatus according to one of the above described embodiments and a field device interface, which is secured to the housing and designed to enable a wired data conductive connection to a field device.

As regards the field device, the object of the invention is achieved by a field device for automation technology, which includes an apparatus according to one of the above described embodiments.

As regards the system, the object is achieved by a system of automation technology, wherein the system has a radio adapter of the above described embodiment, a field device, which is connected via the field device interface data conductively with the radio adapter, and a superordinated unit, which exchanges data according to the first radio standard bidirectionally with the radio adapter, and a service unit, which exchanges data according to the second radio standard bidirectionally with the radio adapter.

An advantageous, further development of the system of the invention provides that the data, which are exchanged between the service unit and the radio unit according to the second radio standard, serve to parameter the field device by the service unit via the radio unit.

As regards the method, the object of the invention is achieved by a method for parametering a field device, or a radio, or wireless, adapter, of automation technology, wherein parameter data are transmitted wirelessly between a service unit and the field device and/or the radio adapter and wherein the parameter data are exchanged via an antenna, which also is used for transmitting process data, so that the field device and/or the radio adapter are/is correspondingly parametered.

An advantageous form of embodiment of the method of the invention provides that for parametering the field device the parameter data are wirelessly communicated between the service unit and the radio adapter and the parameter data are communicated between the radio adapter and the field device by wire.

The invention will now be explained in greater detail based on the appended drawing, the figures of which show as follows:

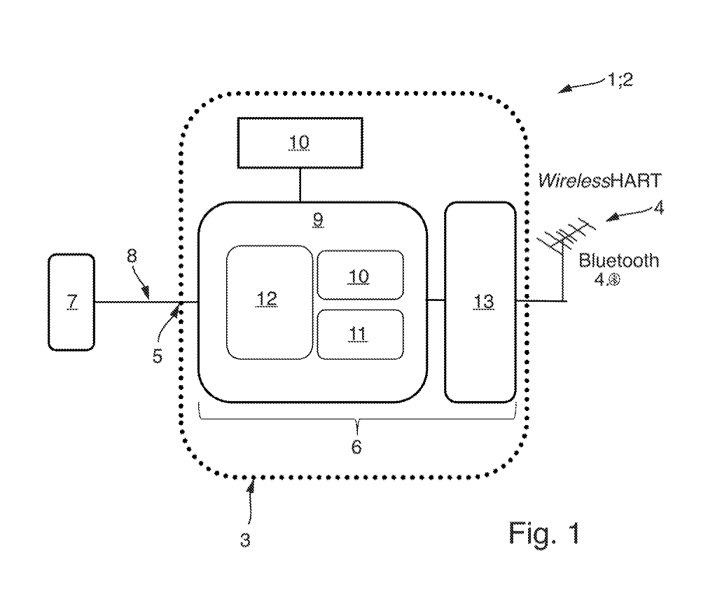

FIG. 1 a schematic representation of an apparatus of the invention in the form of a radio module, and

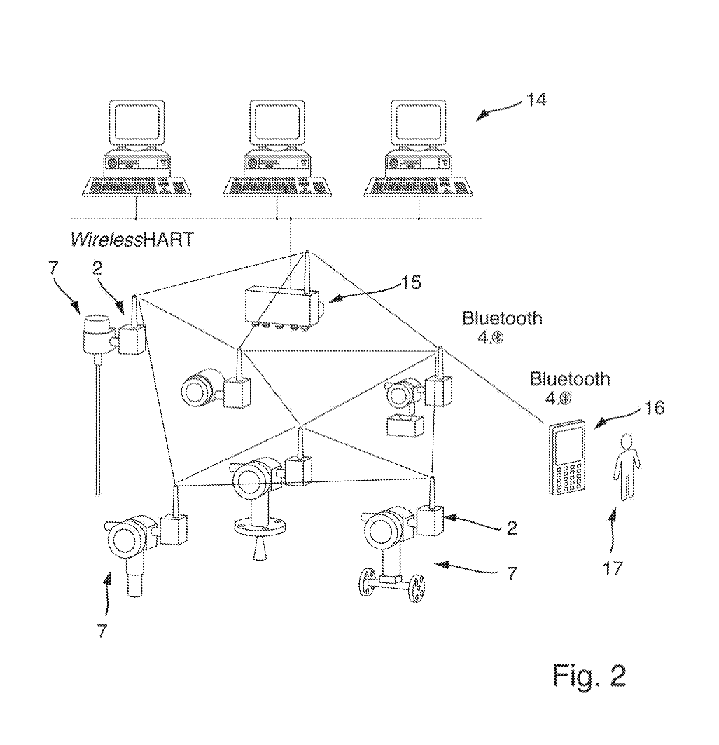

FIG. 2 a schematic representation of an automation technology system of the invention.

FIG. 1 shows a schematic representation of an automation technology apparatus 1 of the invention in the form of a radio, or wireless, adapter 2. Radio adapter 2 includes a housing 3, a radio antenna 4, which is secured externally on the housing 3, a field device interface 5 for connecting a field device 7 arranged separated from the radio adapter 2, and a communication electronics 6.

Via the field device interface 5, a wired connection is established between the radio adapter 2 and the field device 7 of automation technology. Such a wired connection 8 can be, for example, a 4.20 mA electrical current interface, and/or a two-wire line with digital protocol, e.g. HART. Because of the wired connection 8, for example, the process data registered by the field device 7 can be transferred to the radio module 2, so that these can be transmitted from the radio module 2 to a superordinated unit 14, 15, for example, a process control system 14, a gateway 15, etc. Via the wired connection, however, also parameter data serving for configuration, or parametering, the field device 7 can be transferred bidirectionally between the radio adapter 2 and the field device 7.

Furthermore, the field device interface 5 can also be designed to transfer energy from the radio adapter 2 for operation of the field device 7. This can occur, for example, likewise via the wired connection 8 or alternatively via a separately embodied, energy supply line, or lines. The energy provided from the radio adapter 2 to the field device 7 can come, for example, from an internal battery, which is located in the housing 3 of the radio, or wireless, adapter 2. Alternatively, the radio adapter 2 can also be supplied with energy via a power supply, so that also the energy provided for the field device 7 comes from the power supply. The power supply can, in such case, be provided as part of the internal communication electronics 6 or alternatively as a separately embodied power supply, which is connected with the communication electronics 6.

The housing 3 of the radio, or wireless, adapter 2 is preferably of a metal material. Externally secured to the housing 3 are the field device interface 5 and the antenna 4. Both the field device interface 5 as well as also the antenna 4 are connected with the internal communication electronics 6, for example, using feedthroughs through the housing.

The communication electronics 6 arranged within the housing 3 is adapted in such a manner that data, for example, in the form of process variables, or process variable data, are transmittable via the antenna wirelessly to and from a superordinated unit 14, 15 bidirectionally according to a first radio standard. By way of example, in this way, process data registered by the field device and transferred via the field device interface to the radio module can be transmitted further via the radio module according to the wireless HART standard to a control system or gateway.

Wireless HART is a communication-, or radio standard, which is set forth in the HART-7 specification and standardized as IEC 62591. Typically, wireless HART is applied for the construction of industrial fieldbusses. The radio transmission is based, in such case, on the wireless communication standard IEEE 802.15.4. Alternatively to the wireless HART standard, the first radio standard can, however, also comprise ISA100.11a. ISA100.11a is likewise a communication-, or radio, standard applied in automation technology. Typically, the communication electronics 6 includes for this a microprocessor 9, in which a first software stack 10 for the first radio standard is running, so that a conversion of process data occurs according to the first radio standard and, vice versa.

Furthermore, the communication electronics 6 is adapted in such a manner that data in the form of parameter data are transmittable via the same antenna wirelessly and bidirectionally to and from a service unit. The wireless transmission is based, in such case, on a second radio standard, which is different from the first radio standard. Preferably, both the first and second radio standards operate based on the IEEE 802.15.4 standard. Thus, for example, the first radio standard can operate based on the wireless HART or ISA100.11a standard and the second radio standard based on the Bluetooth standard or a variant modified therefrom. Such a modified variant can be, for example, Bluetooth Low Energy (LE). In turn, there runs typically, for this, a second software stack 11 in the microprocessor 9, which cares for converting parameter data in accordance with the second radio standard and vice versa.

In order to enable the transmitting and receiving of data by means of both the first and second radio standards via a single antenna 4, the communication electronics 6 includes an antenna control unit 13. Used as antenna control unit can be, for example, a WL1831MOD of Texas Instruments or even an RS9113 n-Link module of Redpine.

Running in the microprocessor can be, furthermore, a process data processing software, which performs further processing of the process data, which are transferred from the field device to the radio adapter. This can be, for example, for linearizing or even units conversion. The process data processing software is not absolutely necessary, yet it enables more extensive options, when a connecting of the field device to the radio adapter occurs via the 4.20 mA electrical current interface. Thus, for example, besides the pure measured value also corresponding units of the measured value can be transmitted wirelessly via the antenna.

In an alternative embodiment of the apparatus of the invention, a field device includes the above described housing, the radio antenna and the communication electronics 6. In the case of this embodiment, no separate field device interface is provided for the wired connecting of the field device to a radio adapter.

A radio adapter 2, or field device 7, which is embodied such as above described, can, thus, be parametered wirelessly by a corresponding service unit 16. For this, the data in the form of parameter data are transmitted between the service unit 16 and the radio adapter 2, or the field device 7, wirelessly according to the second radio standard. Both the data in the form of is process data as well as also the data in the form of parameter data are received and transmitted via the same antenna of the radio, or wireless, adapter 2, or field device 7.

Based on the parameter data received, or transmitted, by the radio adapter 2, or the field device 7, then the parametering is performed. Thus, for example, the radio adapter 2 or the field device 7 per se can be parametered. Likewise, a parametering of a field device 7, which is connected via the wired data line with a radio adapter 2 of the invention can occur in such a manner that the parameter data are communicated between the radio adapter 2 and the service unit 16 wirelessly and between the radio adapter 2 and the field device 7 by wire. In this case, the radio adapter 2 serves virtually as an interface system.

Such a parametering offers, moreover, also the advantage that an above mentioned apparatus serving for the transmission of the configuration- and/or parameter data and placed between the service unit 16 and the field device 7 or radio adapter 2, is no longer required.

FIG. 2 shows a schematic representation of an automation technology system of the invention. The system includes a number of field devices 7, which are connected with above described radio adapters 2, so that process data can be exchanged between the field devices 7 and the superordinated unit 15 based on the first radio standard. In FIG. 2, the superordinated unit is a gateway 15, which, in turn, communicates with the process control system 14 via wireless HART. Another option is, however, also provided by an embodiment, in the case of which the radio adapters 2, and, thus, also the field devices 7, communicate wirelessly and directly with the process control system 14. FIG. 2 shows, furthermore, an operator 17, who is parametering a particular field device 7 via a service unit 16. For this, the service unit communicates via the second radio standard, for example, Bluetooth LE, with the radio adapter, which forwards the corresponding parameter data via the wired connection to the field device 7. Of course, also the radio adapter 2 can be parametered with the assistance of the service unit via radio, i.e. using the second radio standard. The operator 17 has, thus, the opportunity to perform a parametering of a radio, or wireless, adapter, or field device, without having to open the housing.

### LIST OF REFERENCE CHARACTERS

1 apparatus
2 radio adapter
3 housing
4 radio antenna
5 field device interface
6 communication electronics
7 field device
8 wired connection
9 microprocessor
10 first software stack
11 second software stack
12 process data processing software
13 antenna control unit
14 process control system
15 gateway
16 service unit
17 operator

1-11. (canceled)

12. A radio adapter for automation technology, comprising:
a housing;
a radio antenna externally mounted on the housing; and
a communication electronics arranged within the housing and data conductively connected with the radio antenna, wherein the communication electronics are adapted to communicate data bidirectionally according to a first radio standard wirelessly via the radio antenna to and from a superordinated unit, wherein the communication electronics are further adapted to communicate data bidirectionally according to a second radio standard wirelessly via the radio antenna to and from a service unit.

13. The radio adapter as claimed in claim 12, wherein the first radio standard and the second radio standard operate based on the IEEE 802.15.4 standard.

14. The radio adapter as claimed in claim 12, wherein the first radio standard includes wireless HART or ISA100.11a.

15. The radio adapter as claimed in claim 14, wherein the second radio standard includes Bluetooth or a variant modified therefrom.

16. The radio adapter as claimed in claim 12, wherein the housing includes a metal housing body or a housing body of a synthetic material resistant to radio transmission.

17. The radio adapter as claimed in claim 12, further comprising:
a field device interface, wherein the field device interface is secured to the housing and designed to enable a wired data conductive connection to a field device.

18. A field device for automation technology, comprising:
a radio adapter including:
a housing;
a radio antenna externally mounted on the housing;
a communication electronics arranged within the housing and data conductively connected with the radio antenna, wherein the communication electronics are adapted to communicate data bidirectionally according to a first radio standard wirelessly via the radio antenna to and from a superordinated unit, wherein the communication electronics are further adapted to communicate data bidirectionally according to a second radio standard wirelessly via the radio antenna to and from a service unit; and
a field device interface, wherein the field device interface is secured to the housing and designed to enable a wired data conductive connection to a field device.

19. A system of automation technology, comprising:
a radio adapter including:
a housing;
a radio antenna externally mounted on the housing;
a communication electronics arranged within the housing and data conductively connected with the radio antenna, wherein the communication electronics are adapted to communicate data bidirectionally according to a first radio standard wirelessly via the radio antenna to and from a superordinated unit, wherein the communication electronics are further adapted to communicate data bidirectionally according to a second radio standard wirelessly via the radio antenna to and from a service unit; and
a field device interface, wherein the field device interface is secured to the housing and designed to enable a wired data conductive connection to a field device;
a field device connected via the field device interface data conductively with the radio adapter;
a superordinated unit embodied to exchange data according to the first radio standard bidirectionally with the radio adapter; and
a service unit embodied to exchange data according to the second radio standard bidirectionally with the radio adapter.

20. The system as claimed in claim 19, wherein data exchanged between the service unit and the radio adapter according to the second radio standard serve to parameter the field device by the service unit via the radio adapter.

21. A method for parametering a field device of automation technology, comprising:
providing a radio adapter comprising:
a housing;
a radio antenna externally mounted on the housing;
a communication electronics arranged within the housing and data conductively connected with the radio antenna, wherein the communication electronics are adapted to communicate data bidirectionally according to a first radio standard wirelessly via the radio antenna to and from a superordinated unit, wherein the communication electronics are further adapted to communicate data bidirectionally according to a second radio standard wirelessly via the radio antenna to and from a service unit; and
a field device interface, wherein the field device interface is secured to the housing and designed to enable a wired data conductive connection to a field device;
providing a field device and connecting the field device via the field device interface data conductively with the radio adapter; and
transmitting parameter data wirelessly between a service unit and the field device via the radio adapter, wherein the parameter data are exchanged via the radio antenna so that the field device is correspondingly parametered.

22. The method as claimed in claim 21, wherein for parametering the field device the parameter data are wirelessly communicated between the service unit and the radio adapter and the parameter data are communicated between the radio adapter and the field device by wire.
